(19) United States
(12) Patent Application Publication
(10) Pub. No.: US 2019/0108546 A1
(43) Pub. Date: Apr. 11, 2019

(54) PROVIDING TARGETED COMMUNICATIONS BASED ON TRAVEL RELATED DATA

(71) Applicant: MasterCard International Incorporated, Purchase, NY (US)

(72) Inventors: Emma Goodyear, Rhostyllen (GB); Joanne Elizabeth Ollier, Crewe (GB)

(21) Appl. No.: 15/730,439

(22) Filed: Oct. 11, 2017

(51) Int. Cl. G06Q 30/02

(52) U.S. Cl. CPC G06Q 30/0255; G06Q 30/0261; G06Q 50/14; G06Q 30/0252; G06Q 30/0239

(57) ABSTRACT

Described are methods, systems and apparatus for using point-in-time, travel-related data purchase transaction data to provide pertinent communications to a cardholder. In an embodiment, a travel decision engine obtains authorized purchase transaction data from a transaction database, determines that a particular purchase transaction is travel related, identifies a transaction type and a transaction size, and determines a travel status of the cardholder. The travel decision engine then assigns a treatment based on the travel status, selects a travel related message based on the treatment, and transmits the travel related message to the cardholder.

### FIELD OF THE INVENTION

Embodiments described herein generally relate to methods and systems for using point-in-time, travel-related data to provide pertinent communications to a cardholder. More particularly, a travel decision engine processes the point-in-time, payment card level data to ascertain a precise travel-related offer and/or communication to transmit to the cardholder at the most appropriate time.

### BACKGROUND

Millions of consumer transactions occur daily using payment cards, such as credit cards, debit cards, prepaid cards, and the like financial products. A larger percentage of such consumer transactions are currently being performed by consumers using mobile devices, such as smartphones, which may include, for example, a digital wallet and/or payment application that can be used to conduct a purchase transaction. When these mobile device financial transactions occur, corresponding data records are stored or recorded in databases, which can then be used, for example, in settlement and financial recordkeeping (e.g., to satisfy government requirements and/or government regulations).

Consumer transaction data can be mined and analyzed to determine trends, statistics, and/or to perform other types of analysis. In some cases, such consumer transaction data are mined for specific advertising goals, such as to provide targeted offers to payment card account holders. For example, systems are known that utilize categories and sub-categories to organize purchasing information generated using credit cards, debit cards, checks and the like, and then to process the customer purchase information to generate customer preference information that can be used to create and transmit targeted offers.

It would be advantageous to provide methods and systems that use point-in-time, travel-related data to provide pertinent communications to a cardholder both before the cardholder engages in travel and while he or she is traveling.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram illustrating a consumer transaction system according to some embodiments of the disclosure;

FIG. 2 is a flow table illustrating a process for determining cardholder travel status depending on transaction type and transaction size according to some embodiments of the disclosure;

FIG. 3 is a table illustrating example treatment and/or communications which can be transmitted to a cardholder according to some embodiments of the disclosure;

FIG. 4 is a block diagram of a travel decision engine according to some embodiments of the disclosure; and

FIG. 5 flowchart illustrating an implementation of a process using point-in-time, travel-related data to provide pertinent communications to a cardholder in accordance with some embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “consumer” may be used interchangeably with the term “cardholder” or “user” and such terms are used herein to refer to a consumer, person, individual, business or other entity that owns (or is authorized to use) a financial account such as a payment card account (for example, a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment network that handles debit card and/or credit card transactions and the like. Moreover, as used herein the terms “payment network,” “payment card system” and/or “payment system” refer to a system and/or network for processing and/or handling purchase transactions and related financial transactions, which may be operated by a payment card system operator such as Mastercard International Incorporated (the assignee of the present application), or a similar system. In some embodiments, the term “payment card system” may be limited to systems in which member financial institutions (such as banks) issue payment card accounts to individuals, businesses and/or other entities or organizations.

As used herein, the term “issuer” is used to refer to the financial institution or entity that issues a payment account (such as a debit or credit account) to a cardholder. The issuer of a payment card maintains the payment card accounts of its cardholders. As used herein, the term “acquirer” refers to a financial institution or other entity which has a relationship with a merchant who accepts payment cards for payment of transactions entered into by cardholders. To initiate transactions in the payment card system, merchants accept payment cards and transmit authorization requests to acquirers.

As used herein, a mobile device may be configured with a payment application that allows the mobile device to conduct payment transactions using a “mobile payment account” issued by a “mobile payment account issuer”.

As used herein, the term “cardholder present” transaction (CHP transaction) is used to refer to a purchase transaction wherein a consumer or cardholder is physically at the merchant's point of sale (POS) device or POS terminal, and utilizes his or her payment card account to purchase an item or service. Conversely, a “cardholder not present” transaction (CHNP or CNP transaction) refers to a payment transaction that occurs where the cardholder does not or cannot physically present the card for a merchant's visual examination at the time that an order is given and payment effected. Examples of cardholder not present (CHNP) transactions include, but are not limited to, purchase transactions that occur over the Internet, mail-order purchase transactions that occur via mail or facsimile, and/or purchase transactions that occur through use of a phone (either by use of a cell phone or land line telephone).

In general, and for the purpose of introducing concepts of novel embodiments described herein, disclosed are systems and methods relating to using point-in-time, card level data (such as transaction value or transaction size data, merchant category code (MCC) data, cardholder present status data, and location data) to determine a consumer's likely travel plans and/or travel status, and then to generate and transmit one or more pertinent messages to that consumer. For example, the point-in-time, card level data may be used to determine that the consumer just arrived at a new location, or that the consumer is still travelling (in-travel), or that the consumer is preparing to travel (that travel is imminent, or that the consumer is due to travel soon). Then, depending on the consumer's travel status, pertinent messages can be generated (such as vacation item offers, travel item offers, loyalty points offers, and the like) and then transmitted to the consumer. Such messages can be transmitted to the consumer in any number of ways, for example, electronically via text message to a consumer's smartphone, via postal mail (for example, in advance of a planned vacation trip) to the customer's residence, via telephone call to a consumer's land line by a customer service representative, via e-mail to the consumer's e-mail account, and the like. The targeting of such pertinent communications and/or travel related offers can be beneficial to cardholders, and can also enhance both cross border and overall payment card account usage of those cardholders to the benefit of their issuer financial institutions (FIs) and/or a payments processing company (such as Mastercard International Incorporated, the assignee of the present application), as well as driving increased marketing campaign sales for associated advisor and/or service manager entities. Thus, in some embodiments a travel decision engine is configured to ascertain the most appropriate offer and/or message, and to transmit that travel related offer and/or communication to the consumer at the right time.

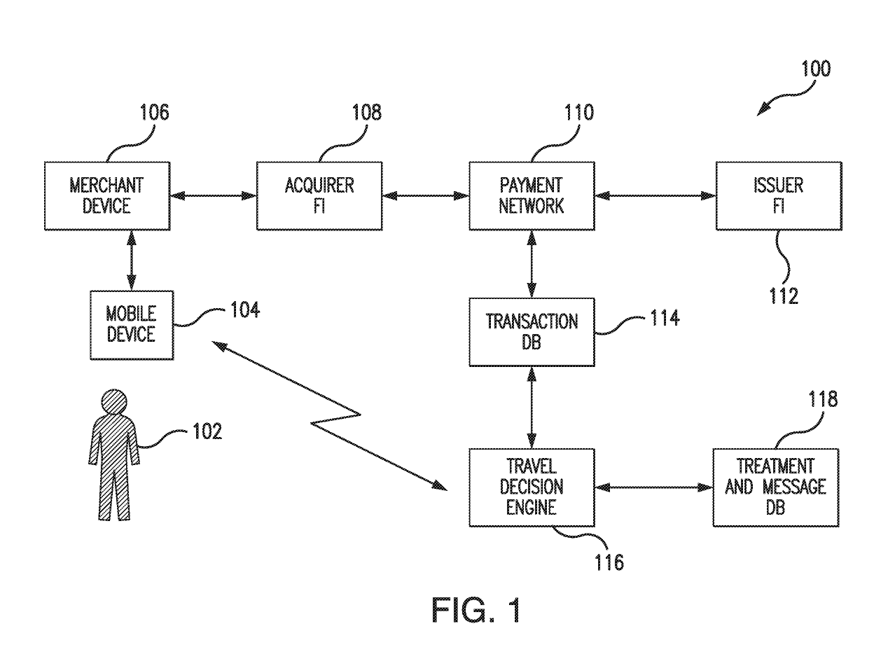

Features of some embodiments will now be described by reference to FIG. 1, which depicts a transaction system diagram 100 including certain components and/or participants in an illustrative consumer transaction pursuant to the present disclosure. Each of the blocks or components shown in FIG. 1 may represent a computer or computer system (which may include one or more processors and/or controller circuits) operable to provide the functionality described herein. A cardholder 102 may operate a mobile device 104 to conduct a purchase transaction with a merchant device 106. The merchant device 106 may be, for example, a point-of-sale (POS) device such as an electronic cash register and the like, or may be a mobile device, such as a smartphone, configured for conducting transactions, including financial transactions (such as purchase transactions and/or payment transactions). The consumer's mobile device 104 may be a mobile phone (such as, for example, a “smartphone” configured to operate with an operating system such as the Android® operating system or the like), or may be a portable computing device (such as a tablet computer) with the same or different operating system. Thus, the mobile device 104 has a payment application installed thereon and/or associated payment circuitry (such as near-field communication (NFC) components) which allows the mobile device 104 to operate as a payment device. The mobile device 104 may therefore be presented by the cardholder 102 at a merchant POS terminal 106 to initiate a payment transaction.

It should also be understood that, in some embodiments the cardholder 102 may present another form of payment, such as a payment card (such as a plastic or metal payment card, which is not shown) at the merchant device 106. Furthermore, in some embodiments the cardholder 102 may purchase a service or item from a merchant's website (not shown) by utilizing a web browser of the mobile device 104 (or via a personal computer (not shown) or the like). In such a case, the merchant device 106 may constitute a server computer or computer system that is configured for providing a shopping experience to the consumer via a network, such as the Internet (not shown).

Referring again to FIG. 1, also depicted is a merchant acquirer FI computer 108 operably connected to the merchant device 106 and to a payment network 110. The payment network is operably connected to an Issuer FI computer 112 and to a transactions database 114. The transaction database 114 is also operably connected to a travel decision engine 116, which in turn is operably connected to a treatment and message database 118. As shown, in some embodiments the travel decision engine 116 is configured for wireless communications with the cardholder's mobile device 104. The travel decision engine 116 may include one or more processors, controllers, computers and/or computer systems (not specifically shown) and/or other electronic components such as input devices, output devices and/or communication devices (not specifically shown). Also, for ease of understanding only one merchant device, acquirer FI, payment network, issuer FI, travel decision engine, treatment and messaging database, and cardholder mobile device is depicted in FIG. 1, but it will be readily appreciated that practical embodiments of the transaction system 100 would include a plurality of such components. In addition, in some implementations the treatment and message database 118 may periodically be updated, for example, with new and/or modified treatments and/or messages. For example, a payment processing entity such as Mastercard International Incorporated may periodically (i.e., weekly, bi-weekly and/or monthly) update the treatment and message database 118 with modified and/or new offer data and/or communication data to match one or more target audience customers.

Referring again to FIG. 1, when a cardholder initiates a purchase transaction, the merchant device 106 transmits the purchase transaction data (which may include, for example, merchant identification data, cardholder identification data, item or items purchased data, and a total transaction amount) to the merchant acquirer financial institution (FI) computer 108, which submits a purchase transaction authorization request to the payment network 110. The payment network 110 processes the received data to determine which issuer FI issued the cardholder's payment card account, and then transmits the purchase transaction authorization request to that issuer FI 112 for authorization processing. The issuer FI computer 112 utilizes the data in the authorization request to verify the cardholder's payment card account, ensure that the payment card account is in good standing, and ensure that an adequate credit line is available to cover the total transaction cost of the purchase transaction. If the issuer FI computer 112 determines that the payment card account is in good standing and has an adequate credit line to cover the total transaction cost, then a purchase transaction authorization message is transmitted to the payment network 110. The payment network 110 then transmits the purchase transaction authorization message to the acquirer FI computer 108, which forwards it to the merchant device 106. In some implementations, the merchant device 106 displays a transaction authorization message on a display screen (not shown) for the consumer 101 and a store clerk to read, and the store clerk then permits the consumer 102 to take the purchased items and leave the merchant's retail store.

Referring again to FIG. 1, in some implementations, when the payment network 110 receives the purchase transaction authorization message from the issuer FI computer 112, all of the transaction data associated with the authorized payment transaction (such as consumer identification data, merchant identification data, total transaction cost, and the like) is stored in the transaction database 114. Such processing can occur for many different cardholder accounts involving purchase transaction data associated with purchase transactions that have taken place in countries and/or locations all over the world. In some embodiments, based on the data stored in the transaction database 114, the travel decision engine 116 determines which authorized purchase transactions are associated with travel related data. In particular, the travel decision engine 116 determines if a particular authorized purchase transaction indicates an intent to travel (e.g., booking an airplane flight), and/or indicates arrival at a destination or location away from a cardholder's home (e.g., the first cardholder present transaction in a country other than the cardholder's home country or country of residence). Purchase transaction Tier 3 addendum data can also be utilized to provide more granular detail of the travel related transaction. Such Tier 3 addendum data may include specific purchase transaction line item data, such as merchant name and address, invoice number and tax amount, line item details such as item description, quantity and unit of measure, freight amount, and commodity and product codes. Thus, for example, in the case of an airline ticket purchase, the Tier 3 data may provide the date of departure, the debarking and destination airports, the booking class, and the like.

Next, in some embodiments the travel decision engine 116, for each cardholder account that has been identified as involved in a travel related purchase transaction, assesses or determines the size or value of the transaction (e.g., low, medium or high, which levels or tiers may be predetermined by a payment processing company or issuer FI). For example, travel related purchases of up to fifty U.S. dollars (up to $50) may be in the low category, travel related purchases in the range of more than fifty U.S. dollars and up to one hundred and fifty U.S. dollars (in the range of greater than $50 up to $150) may be in the medium category, and all travel related purchases over one hundred and fifty U.S. dollars (greater than $150) may be in the high category (other currency denominations, such as Euros, may also be utilized to define the category range(s)). Of course, more or less categories may be used, and each such category could be associated with different value amounts and/or different ranges of value amounts. In some implementations, a payments processing entity determines how many levels and/or tiers are to be utilized, and their range(s). The travel decision engine 116 then utilizes the combination of transaction type and transaction size (category) to determine the customer's likely travel status and/or travel plans. Based on the likely travel status, the travel decision engine 116 selects a treatment and/or message and/or offer that is pertinent and/or relevant to the customer and that is associated with their stage of travel (e.g., just arrived, in-travel, travel imminent, due to travel in near future, at their destination, and the like). For example, depending on the travel status of a cardholder, the travel decision engine 116 may transmit a message wirelessly to the cardholder's mobile device 104 to “Register your travel plans with us to use your card abroad and stay protected.” If a determination is made that the cardholder has recently purchased round trip airline tickets, the travel decision engine 116 may transmit a message stating “Use your card to book your next vacation and earn double points.” In yet another example message, if a determination is made that the cardholder has reached his or her travel destination, a message may be transmitted stating “Welcome to New York, earn double points on all of your holiday spending.”

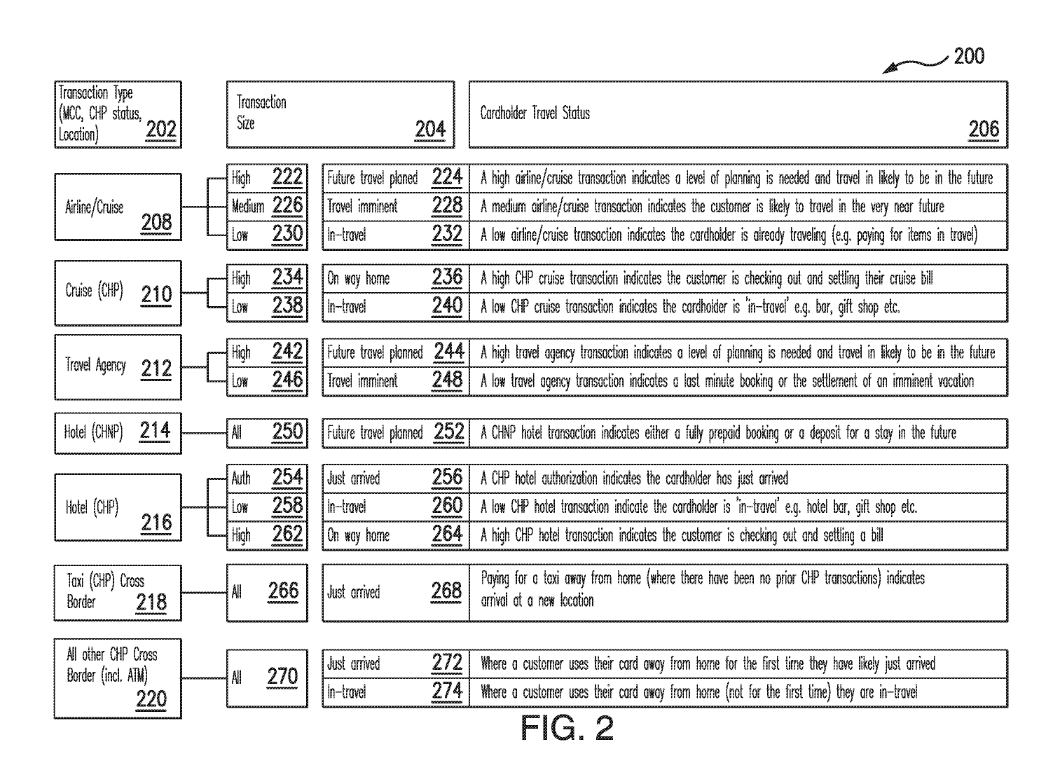

FIG. 2 is a flow table 200 illustrating a process for determining cardholder travel status depending on transaction type and transaction size according to some embodiments. A first column 202 lists different travel related transaction types, which may be identified by one or more of merchant category code (MCC) data, cardholder present status data, and/or location data associated with an authorized purchase transaction. The second column 204 lists transaction size considerations associated with each transaction type, and the third column 206 lists associated cardholder travel status data (which depends on the transaction type and the transaction size). In some implementations, a transaction type 202 may include, and airline and/or cruise purchase transaction 208, a cardholder present (CHP) cruise purchase transaction 210 (typically indicating a purchase transaction occurring aboard a cruise ship), a travel agency purchase transaction 212, a hotel purchase transaction 214 (wherein the cardholder is not present (CHNP) indicating an online purchase transaction involving booking of a hotel room), a hotel room purchase transaction 216 (wherein the cardholder is present (CHP) indicating a purchase transaction at the hotel during a stay) a cross boarder taxi purchase transaction 218 (wherein the cardholder is present (CHP) indicating a taxi ride in a foreign country), and other cross boarder purchase transactions 220 (which may include obtaining currency at an automatic teller machine (ATM), indicating purchases occurring during a vacation or business trip to a foreign country). In some embodiments, further transaction types 202 may be added and/or modified by, for example, a payment processing entity and/or an issuer FI.

Referring again to FIG. 2, as indicated by column 204, the determination of a cardholder's travel status (as shown in column 206) changes depending on the transaction size for each or the example transaction types 208-222. For example, if the transaction type is an airline or cruise related transaction 208, then a high transaction amount (for example, several thousand dollars for an airline ticket) indicates 224 that the cardholder is planning future travel. That is, a high airline and/or cruise related purchase transaction indicates a level of planning is needed and that travel is likely to be in the future. In this case, a planned travel message may be sent to the cardholder. Conversely, a medium size 226 airline purchase transaction and/or cruise related purchase transaction (for example for an amount between $250 and $3000 in a month) indicates that travel is imminent, as it shows that the cardholder is likely to travel in the very near future (such purchases may include, for example, flights due to be taken within the next two months). In this case, a near-planned travel message may be transmitted to the cardholder. In addition, a low value 230 airport purchase transaction and/or cruise related purchase transaction (for example, less than $250 in a month) indicates that travel is occurring, as it indicates the cardholder is likely already traveling (such purchases may include, for example, gift shop purchases aboard a cruise ship or duty free purchases in an airport). In such cases, an in-travel message may be transmitted to the cardholder.

In the case of a cardholder present (CHP) cruise transaction 210 having a high value 234, the cardholder travel status is “on the way home” 236 because such a high, cardholder present transaction indicates that the customer is checking out and/or settling his or her cruise bill. Conversely, for a cardholder present (CHP) cruise transaction 210 having a low value 238, the cardholder travel status is “in-travel” 240 because such purchases indicate that the cardholder or consumer is purchasing items in the gift shop, or drinks in a bar.

In the case of a travel agency purchase 212, a high value 242 indicates that future travel is planned, whereas a low value 246 indicates that travel is imminent 248. For example, a low value 246 transaction (which may be for an amount less than three-thousand dollars ($3000)) may indicate a last-minute booking or settlement of an imminent vacation.

Referring again to FIG. 2, when a hotel card not present (CHNP) transaction 214 occurs, all transactions 250 (regardless of value or amount) indicate that future travel is planned 252. Examples of such CHNP hotel transactions include, but are not limited to, a fully prepaid booking or a deposit for a stay in the future. Conversely, when a cardholder present (CHP) hotel transaction 216 is found, then a cardholder account authorization 254 indicates that the consumer has just arrived, whereas a low transaction 258 indicates that the cardholder is in-travel 260, for example, at the hotel's gift shop, or in the hotel bar, and the like. For a CHP hotel transaction 216 having a high value 262, then the cardholder is on the way home 264 as this indicates that the customer or consumer is checking out of the hotel and settling the bill.

Referring again to FIG. 2, if a cross-border taxi, cardholder present (CHP) transaction 218 occurs, then for all transaction amounts 266, this indicates that the consumer or cardholder has arrived at a new location (because he or she is paying the taxi fare). In addition, all other cross-border, cardholder present (CHP) transactions 220 at all transaction sizes 270 indicate that the cardholder either just arrived 272 (when the cardholder uses his or her payment card account away from a home country for the first time) or is traveling 274 (when the cardholder uses his or her payment card account in a different country after the first time).

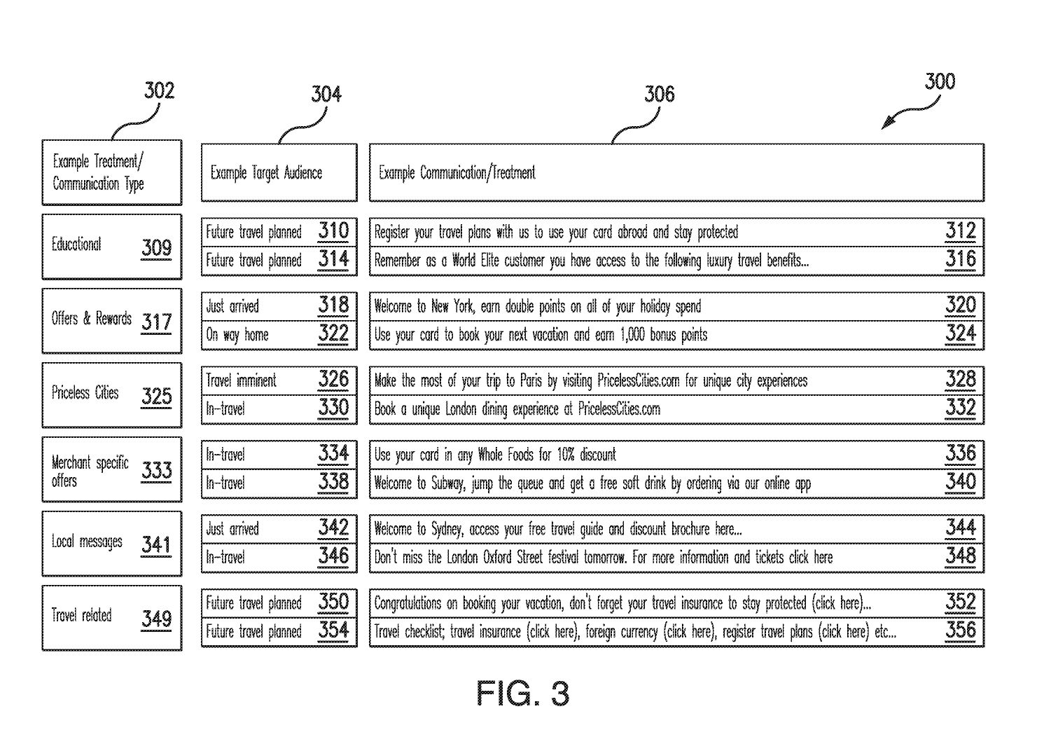

FIG. 3 is a table 300 illustrating example treatment and/or communications which can be transmitted to a cardholder according to some embodiments. The message and/or communication may be transmitted in one or more ways, such as via text message, e-mail, and/or postal mail (which may depend on cardholder preference or the like). Referring to FIG. 3, a first column 302 lists different example treatments and/or communications, which may be specified and/or predetermined by an issuer financial institution (FI) that issued the cardholders payment card account. Thus, an educational 309 message may be selected and transmitted to a cardholder when he or she is planning 310 (or 314) a trip. For example, a message may be sent 312 to a cardholder stating: “Register your travel plans with use to use your card abroad and stay protected,” or when the consumer is a premium-level cardholder the message 316 may be to “Remember as a World Elite customer you have access to the following luxury benefits: free concierge service, discount taxi rates, discount hotel restaurant rates . . . ”. An offer and/or rewards message 317 may be transmitted to a cardholder when the cardholder has just arrived 318 at their destination, and thus a message 320 such as “Welcome to New York, earn double points on all of your holiday spending!” may be transmitted to the consumer's mobile device. When the cardholder is on his or her way home 322, a message 324 such as “Use your card to book you next vacation and earn 1,000 bonus points” may be sent to the cardholder.

Referring again to FIG. 3, if a cardholder purchase transaction indicates that the cardholder has is contemplating travel (or traveling) to any “Priceless Cities” 325 destinations (which cities may be specified by a payments processing company, such as Mastercard International Incorporated, or by member financial institutions, such as banks, which issue payment card accounts), then when travel is imminent 326, a message may be transmitted stating: “Make the most of your trip to Paris by vising PricelessCities.com for access to unique city experiences.” If instead the cardholder is traveling 330, then a message may be transmitted stating: “Book a unique London dining experience at PricelessCities.com.” In some cases, when a consumer is in-travel then merchant specific offers 333 may be provided. For example, in one case when it is apparent that a cardholder is in-travel 334 due to a transaction occurring in or near a shopping district, a message 336 may be sent to the cardholder's mobile device stating: “Use your card in any Whole Foods™ store for a 10 percent discount.” Similarly, a message 340 may be sent stating: “Welcome to Subway, jump the queue and get a free soft drink by ordering via our online app.”

Referring again to FIG. 3, local messages 341 can be sent when the cardholder has just arrived 342 or is in-travel 346 to a destination. For example, when a determination is made that the cardholder or consumer just arrived 342, a local message stating: “Welcome to Sydney, access your free travel guide and discounts brochure here . . . ” may be transmitted to a mobile device of the consumer for display on a display screen. Alternately, when a determination is made that the cardholder or consumer is in travel 346 to a destination, a local message could be sent stating: “Don't miss the London Oxford Street festival tomorrow. For more information and tickets click here.” Travel related messages 349 could be sent when the c cardholder is planning future travel 350, 354, such as: “Congratulations on booking your vacation; don't forget your travel insurance to stay protected [click here],” or “Travel Checklist: travel insurance [click here], foreign currency [click here], register travel plans [click here].”

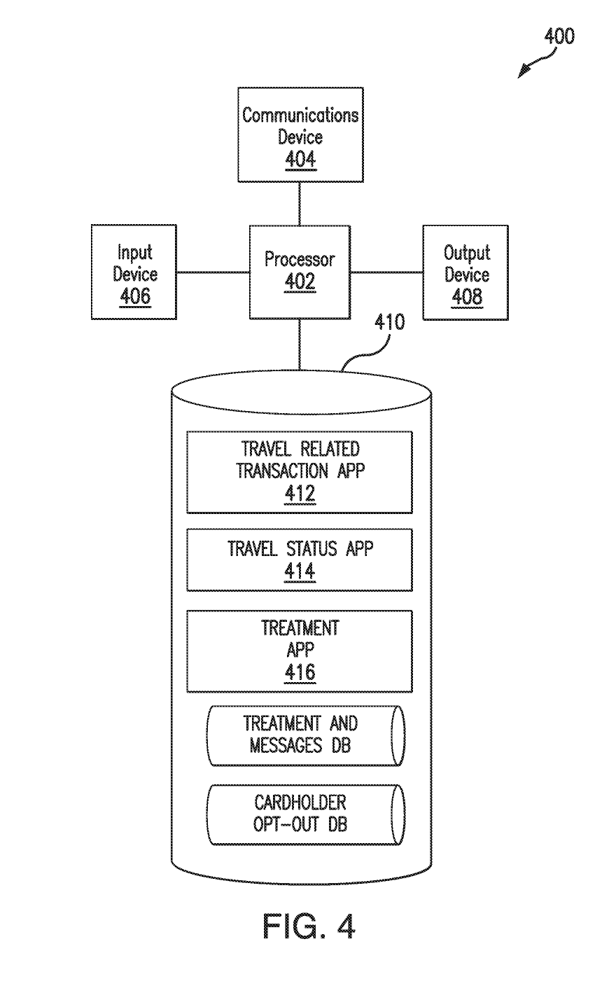

FIG. 4 is a block diagram of a travel decision engine 400 according to an embodiment. A computer processor 402 is operatively coupled to a communication device 404, an input device 406, an output device 408, and a storage device 410.

The computer processor 402 may be constituted by one or more processors. In addition, the one or more processors may be configured and/or customized to execute processor-executable steps, contained in program instructions described herein, so as to control the travel decision engine computer 400 to provide desired functionality.

Communication device 404 may be used to facilitate communication with, for example, other devices (such as consumer mobile devices 104, transaction databases 114, and treatment and message databases 118, as shown in FIG. 1). Communication device 404 may, for example, have capabilities for sending and receiving messages over wireless mobile telephone networks, via the Internet, and/or by engaging in data communications over conventional computer-to-computer data networks.

Input device 406 may comprise one or more of any type of peripheral device typically used to input data into a computer. For example, the input device 406 may include a touchscreen and/or a keyboard and/or a mouse. Output device 408 may comprise, for example, a display component and/or a printer and the like.

Storage device 410 may comprise any appropriate information storage device or memory, including combinations of magnetic storage devices (e.g., magnetic tape and hard disk drives), solid state devices (SSDs), optical storage devices such as compact discs (CDs) and/or DVDs, and/or semiconductor memory devices such as Random Access Memory (RAM) devices and Read Only Memory (ROM) devices, as well as flash memory and/or bubble memory. Thus, the storage device 410 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Storage device 410 stores one or more programs or applications for controlling the processor 402. The programs comprise program instructions that contain processor-executable process steps of the travel decision engine computer 400, including, in some cases, process steps that constitute processes provided in accordance with principles of the present invention, as described herein.

In some embodiments, the programs stored by the storage device 410 may include a travel related transaction application 412 that screens and/or filters authorized payment transaction message data to determine whether or not that transaction is travel related. For example, the travel related transaction application looks at merchant category code data, cardholder present status and/or location data found in an authorized purchase transaction and makes a determination as to whether that particular transaction is travel related. In addition, storage device 410 may store a travel status application 414 for determine that cardholders travel status based on the transaction type and the transaction size, as explained herein. The storage device 410 may also store a treatment application 416 for determining or selecting a treatment type and/or appropriate travel message and/or an appropriate travel communication for transmission to a cardholder, as explained herein.

In addition, in some embodiments the storage device 410 may store one or more databases that are maintained by the travel decision engine computer 400. Among these databases may be a treatment and messages database 418, and a cardholder opt-out database 420. The travel decision engine computer 400 may be operable to obtain data to populate such databases directly from participating issuer financial institutions (FIs) and/or participating payment processing entities.

The application programs of the smart preferences computer 400 may be combined in some embodiments, as convenient, into one, two or more application programs. Moreover, the storage device 410 may store other programs, such as one or more operating systems, device drivers, database management software, web hosting software, and the like.

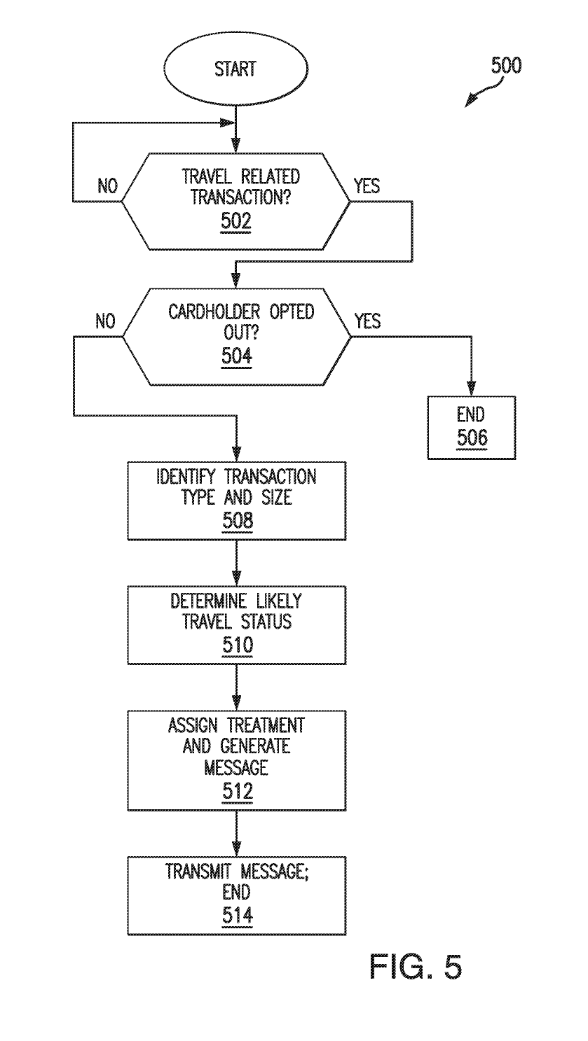

FIG. 5 is a flowchart of a process 500 for using point-in-time, travel-related data to provide pertinent communications to a cardholder in accordance with some embodiments. A travel decision engine determines 502 whether an authorized purchase transaction is or is not a travel related transaction. If not, the process loops back to determine if a next authorized purchase transaction is travel related. The travel decision engine makes such a determination based on one or more types of transaction type data associated with the transaction authorization data, such as merchant category code (MCC) data, cardholder present status data, and location data. A MCC is typically assigned to a merchant by an issuer FI when the business first starts accepting payment cards as a form of payment, and may reflect the primary category in which the merchant does business and/or the merchant's name (for example, one MCC can be used for hotels while another MCC is used for office supply stores, etc.). For example, if the MCC data indicates an authorized purchase transaction for a cruise line ticket, an airline ticket, a travel agency service charge, a hotel charge, and/or a taxi charge (for a taxi in a city and/or country different from the cardholder's home city and/or country), or for any transaction completed away from the cardholder's home city and/or home country, then that authorized purchase transaction is deemed to be travel related. The cardholder present status data and the location data is typically included with, or is a portion of, the purchase transaction data.

Referring again to FIG. 5, after determining that an authorized purchase transaction is travel related, the travel decision engine determines 504 whether the cardholder opted-out of receiving travel related communications. Regarding opting-out, in some implementations, the cardholder would have been required to specifically indicate his or her preference to not receive travel related communications. For example, the cardholder may be given the choice to opt-out of receiving travel related communications by an issuer bank at the time he or she applies for the payment card account. In addition, the cardholder may be informed that he or she could opt-out at any time thereafter by visiting the issuer FI's website, accessing their account, and selecting an opt-out option available on the cardholder's profile page to stop receiving travel related communications. Some issuer FIs may also permit the cardholder to opt-out of receiving travel related communications by contacting a customer service representative via telephone or e-mail, and/or to opt-out by mail. Thus, in step 504, if the travel decision engine determines that the cardholder did opt-out of receiving travel related communications, then the process ends 506 with regard to this authorized payment transaction.

However, if the travel decision engine determines 504 that the cardholder did not opt-out of receiving travel related communications, then travel decision engine identifies 508 the transaction type and transaction value (or size of the transaction). For example, the travel decision engine determines, based on at least a portion of the purchase transaction authorization data, an airline and/or cruise purchase transaction, cardholder present (CHP) cruise purchase transactions (which typically relate to a purchase transaction occurring aboard a cruise ship), a travel agency purchase transaction, a hotel purchase transaction 214 (when it is a cardholder not present (CHNP) transaction, this indicates an online purchase transaction involving booking of a hotel room), a hotel room purchase transaction (when it is a cardholder present (CHP) transaction, this indicates a purchase transaction at the hotel during a stay), a cross boarder taxi purchase transaction (when the cardholder is present (CHP), this indicates a taxi ride in a foreign country), and any other cross boarder purchase transactions (which may include obtaining currency at an automatic teller machine (ATM), indicating purchases occurring during a vacation or business trip to a foreign country).

Regarding identifying the size of the transaction, the travel decision engine obtains the total value of the authorized purchase transaction, and in some implementations, may then slot or designate or categorize the purchase transaction as belonging to a predetermined level or tier. For example, based on the total value, a travel related authorized purchase transaction can be designated as belonging to a low value tier, a medium value tier, or a high value tier, which levels or tiers may be predetermined by a payment processing company or issuer FI. In an example, a travel related purchase of seventy-five dollars ($75) or less may be designated as in the low category, a travel related purchase in the range of between seventy-six dollars ($76) and two hundred dollars ($200) may be in the medium category, and all travel related purchases over two hundred and one dollar ($201) may be in the high category. More or less of such levels or categories may be used, and each such level may be associated with a different value amount and/or a different range of values.

Referring again to FIG. 5, after identifying the transaction type and the transaction size, the travel decision engine determines 510 the likely status depending on these two variables. For example, if an authorized purchase transaction type is an airline or cruise related transaction with a high transaction amount (for example, one thousand dollars for an airline ticket), then the travel decision engine determines that the cardholder is planning future travel. That is, a high airline and/or cruise related purchase transaction indicates a level of planning is needed and that travel is likely to be in the future. Conversely, if the travel decision engine identifies a medium size airline and/or cruise authorized purchase transaction, then travel decision engine determines that travel is imminent (as such purchases indicate that travel will occur in the very near future). In another example, if the travel decision engine identifies a low value airport authorized purchase transaction (see item 230 in FIG. 2) and/or cruise authorized purchase transaction, (see item 238 in FIG. 2) then the travel decision engine determines that travel is occurring (as such a purchase transaction indicates the cardholder is likely already traveling; such purchases may include, for example, gift shop purchases onboard a cruise liner or duty free purchase on board an aircraft). Other examples can be found in the table of FIG. 2, and the description of FIG. 2 herein above.

After the travel decision engine determines 510 the likely travel status of a cardholder, the travel decision engine next assigns 512 a treatment and generates or selects an appropriate message that fits the situation (e.g., that fits the transaction type, the transaction size, and the likely travel status of the cardholder). Example treatments and/or message types may include educational messages, offers and rewards, merchant-specific offers, local messages, and other travel related communications (such as an offer to provide a map of a shopping district). Any particular message type may be selected based on the target audience and/or cardholder status in the context of the type of travel. Such treatments and/or communication types and example messages or communications are illustrated in the table of FIG. 3, which is described herein above. After generating and/or selecting an appropriate communication and/or message, the travel decision engine transmits 514 the travel related message or communication, and the process ends.

A travel related message or communication may include, but is not limited to, a message, an advertisement, a promotion, a ticket offer, a travel brochure, a map, and the like. For example, a travel related message that is transmitted to a cardholder may be a message associated with a location, and/or an advertisement for a product or service, and/or a promotional offer, and/or a ticket offer for an event near the cardholder's current location, and/or a map of the cardholder's current location. In addition, a travel related message can include, but is not limited to a vacation item offer, a travel item offer, a loyalty points offer, and the like. Such communications can be transmitted to the consumer or cardholder in a variety of ways and/or formats, for example, via text message to a cardholder's smartphone, via postal mail (for example, in advance of a planned vacation trip), via telephone call to a consumer's land line, via e-mail to the consumer's e-mail account, and the like.

Targeting of pertinent travel related messages and/or communications, which can include one or more travel related offers, can be beneficial or advantageous to a cardholder, helping the cardholder obtain information and/or rewards and/or benefits before, during and after travel. In addition, such point-in-time, travel related communications systems and processes can enhance both cross border and overall payment card account usage of traveling cardholders to the benefit of their issuer FIs (such as issuing banks). Moreover, payment processing companies (such as Mastercard International Incorporated, the assignee of the present application) who provide the authorized purchase transaction data and may provide and/or maintain the travel decision engine and/or the travel decision database, may benefit due to an increase in payment card account transaction processing fees. In addition, the payment processing companies that provide such services to issuer banks may also be able to market other service manager services to those financial institutions resulting in increased revenues. Issuing FIs that offer such a travel related messaging service may also be able to attract consumers to become cardholders, and/or may be able to persuade existing cardholders to purchase associated advisor services from the issuer bank.

As used herein and in the appended claims, the term “computer” should be understood to encompass a single computer or two or more computers in communication with each other. Also, as used herein and in the appended claims, the term “processor” should be understood to encompass a single processor or two or more processors in communication with each other. In addition, as used herein and in the appended claims, the term “memory” and/or “storage device” should be understood to encompass a single memory or storage device or two or more memories or storage devices. Moreover, as used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps, and/or in an order that omits one or more steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for providing point-in-time, travel related communications comprising:
obtaining, by a travel decision engine from a transaction database, authorized purchase transaction data of a purchase transaction associated with a cardholder;
determining, by the travel decision engine, that the purchase transaction is travel related;
identifying, by the travel decision engine, a transaction type and a transaction size;
determining, by the travel decision engine based on the transaction type and the transaction size, a travel status of the cardholder;
assigning, by the travel decision engine, a treatment based on the travel status;
selecting, by the travel decision engine, a travel related message based on the treatment; and
transmitting, by the travel decision engine, the travel related message to the cardholder.

2. The method of claim 1, further comprising;
determining, by the travel decision engine after determining that the purchase transaction is travel related, that the cardholder opted out of receiving travel related communications; and
terminating, by the travel decision engine, the travel related communications process.

3. The method of claim 1, wherein identifying the transaction type comprises determining, by the travel decision engine based on at least a portion of the authorized purchase transaction data, at least one of an airport purchase transaction, a cruise purchase transaction, a cardholder present (CHP) cruise purchase transaction, a travel agency purchase transaction, a cardholder not present (CHNP) hotel purchase transaction, a cardholder present (CHP) hotel purchase transaction, and a cross boarder purchase transaction.

4. The method of claim 1, wherein determining the travel status further comprises categorizing the purchase transaction as belonging to a predetermined tier.

5. The method of claim 1, wherein the transaction type data comprises at least one of merchant category code (MCC) data, cardholder present status data, and location data.

6. The method of claim 1, wherein the travel related message comprises at least one of a message associated with a location, an advertisement for a product or service, a promotional offer, a ticket offer, a travel brochure, and a map.

7. The method of claim 1, wherein transmitting the travel related message to the cardholder comprises at least one of transmitting a text message to a cardholder mobile device, providing instructions to mail the travel related message to the cardholder's residence address, providing instructions to a customer service representative to call a consumer's telephone with the travel related message, and transmitting an e-mail to the consumer's e-mail account.

8. A point-in-time, travel related communications system comprising:
a payment network;
a transaction database operably connected to the payment network; and
a travel decision engine operably connected to the transaction database and to a treatment and message database;
wherein the travel decision engine comprises a travel decision processor operably connected to a storage device, wherein the storage device comprises instructions configured to cause the travel decision processor to:
obtain authorized purchase transaction data of a purchase transaction associated with a cardholder from the transaction database;
determine that the purchase transaction is travel related;
identify a transaction type and a transaction size;
determine a travel status of the cardholder based on the transaction type and the transaction size;
assign a treatment based on the travel status;
select a travel related message based on the treatment; and
transmit the travel related message to the cardholder.

9. The system of claim 8, further comprising a treatment and message database operably connected to the travel decision engine, wherein the storage device comprises further instructions configured to cause the travel decision processor to utilize the treatment and message database to assign the treatment.

10. The system of claim 9, wherein the storage device comprises further instructions configured to cause the travel decision processor to utilize the treatment and message database to select a travel related message.

11. The system of claim 8, wherein the storage device comprises further instructions configured to cause the travel decision processor to, after determining that the purchase transaction is travel related:
determine that the cardholder opted out of receiving travel related communications; and
terminate the travel related communications process.

12. The system of claim 8, wherein the storage device comprises further instructions configured to cause the travel decision processor to identify the transaction type by determining, based on at least a portion of the authorized purchase transaction data, at least one of an airport purchase transaction, a cruise purchase transaction, a cardholder present (CHP) cruise purchase transaction, a travel agency purchase transaction, a cardholder not present (CHNP) hotel purchase transaction, a cardholder present (CHP) hotel purchase transaction, and a cross boarder purchase transaction.

13. The system of claim 8, wherein the storage device comprises further instructions configured to cause the travel decision processor to categorize the purchase transaction as belonging to a predetermined tier.

14. The system of claim 8, further comprising a plurality of cardholder mobile devices, and wherein the storage device comprises further instructions configured to cause the travel decision processor to transmit the travel related message to the cardholder mobile device associated with the purchase transaction.

15. The system of claim 14, wherein the storage device comprises further instructions configured to cause the travel decision processor to transmit at least one of a message associated with a location, an advertisement for a product or service, a promotional offer, a ticket offer, a travel brochure, and a map.

16. The system of claim 14, wherein the storage device comprises further instructions configured to cause the travel decision processor to transmit the travel related message to the cardholder mobile device via at least one of a text message, an audio message, and an e-mail message.

17. A travel decision engine comprising:
a travel decision processor;
a communications device operably connected to the travel decision processor; and
a storage device operably connected to the travel decision processor, wherein the storage device comprises a treatment and messages database and stores instructions configured to cause the travel decision processor to:
obtain authorized purchase transaction data of a purchase transaction associated with a cardholder from a transaction database;
determine that the purchase transaction is travel related;
identify a transaction type and a transaction size;
determine a travel status of the cardholder based on the transaction type and the transaction size;
assign a treatment based on the travel status by using the treatment and messages database;
select a travel related message from the treatment and messages database based on the treatment; and
transmit the travel related message to the cardholder.

18. The apparatus of claim 17, wherein the storage device further comprises a cardholder opt-out database and stores further instructions, after the instructions for determining that the purchase transaction is travel related, configured to cause the travel decision processor to:
determine that the cardholder opted out of receiving travel related communications; and
terminate the travel related communications process.

19. The apparatus of claim 17, wherein the storage device comprises further instructions configured to cause the travel decision processor to transmit the travel related message to a cardholder mobile device associated with the purchase transaction.

20. The apparatus of claim 19, wherein the travel related message comprises at least one of a message associated with a location, an advertisement for a product or service, a promotional offer, a ticket offer, a travel brochure, and a map.
